(19) United States
(12) Patent Application Publication
(10) Pub. No.: US 2009/0204702 A1
(43) Pub. Date: Aug. 13, 2009

(54) SYSTEM AND METHOD FOR NETWORK MANAGEMENT USING SELF-DISCOVERING THIN AGENTS

(75) Inventors: Robert JENSEN, Fredericia (DK); Poul Hassan Agha KROGH, Fredericia (DK); Anders LEHMANN, Holstebro (DK)

Correspondence Address: PILLSBURY WINTHROP SHAW PITTMAN, LLP, P.O. BOX 10500, MCLEAN, VA, 22102, US

(73) Assignee: AUTIQ AS, Fredericia (DK)

(21) Appl. No.: 12/028,160

(22) Filed: Feb. 8, 2008

(51) Int. Cl. G06F 15/173

(52) U.S. Cl. 709/224

(57) ABSTRACT

In one embodiment, a computer-implemented method of managing a computer network includes installing an agent in each of a plurality of network nodes in the network. The agent may be configured to identify one or more types of network resources attached to a particular node with which the agent is associated. One or more roles may be assigned to or by the agent based, at least in part, upon the one or more types of network resources identified by the agent. Functions associated with the identified roles may be executed. Monitoring the status of each agent may also be carried out. In another embodiment, a network management system includes an agent executing within an associated network node of the network. The agent may be configured to operate so as to identify one or more types of resources attached to the network node. The agent may be assigned one or more roles based, at least in part, on an inference based upon the one or more types of attached resources identified by the agent.

This application is related to U.S. application Ser. Nos. 11/960,970 (“Network Discovery System”) and 11/961,021 (“Agent Management System”) both filed on Dec. 20, 2007. The entire contents of each of these applications are incorporated herein by reference.

### BACKGROUND

This application is directed to a system and method for network management using self-discovering thin agents which may be deployed throughout various nodes and network elements of a network to enhance and ease management of the network and its resources.

Agents deployed over a network to monitor computer systems are becoming more prevalent. The advantage of an agent over a remote non-intrusive management approach includes the benefits of a push-strategy, where changes to various network components are “pushed” to a monitoring node when they happen, e.g., without a specific request, in contrast to a “pull” strategy where changes must be requested from each component, network element, or node. Further, the data used at each node or component must be monitored for changes, making use of a local agent more desirable with respect to use of a remote manager with limited access to information.

An “agent” may broadly be defined as a program segment of executable code specifically designed to interact with a computer (including, but not limited, PCs, servers, mobile phones, and any other device with computing functionality), and to access data on the user's behalf, sometimes synonymously used as the term “client.” Similarly, an agent may be defined as an automatic program that is designed to operate on the user's behalf by performing a specific function in the background. When the agent has achieved its goal, it may report to the user and/or a control node. Related concepts include intelligent agents (in particular exhibiting some aspect of Artificial Intelligence, such as learning and reasoning), autonomous agents (capable of modifying the way in which they achieve their objectives), distributed agents (being executed on physically distinct machines), multi-agent systems (distributed agents that do not have the capabilities to achieve an objective alone and thus must communicate), and mobile agents (agents that can relocate their execution onto different processors). The use of the phrase “intelligent agent” implies some type of automatic process which has the ability to communicate with other agents and/or server.

In general, an agent is a background process that performs an action when an event occurs. In networking, an agent may be part of a network management system that resides in workstations and other network devices (called managed elements), and which may collect and act upon the collected information by performing one or more tasks on behalf of the network management system. Agents may also be configured to report collected information about specific devices back to a management node. The management system may run at a central location but in a distributed management system, management subsystems may reside at various points in the network to collect local information that is periodically collected by the main management system.

A client-server relationship exists between the agent and the management system, but the term “agent” is often used for management systems to avoid confusion. For example, in the Simple Network Management Protocol (SNMP) system, which provides a tool for tracking workstations and compiling information about them, agents are called network agents.

As mentioned above, an agent may be considered a program that performs some information gathering or processing task in the background. Typically, an agent is given a very small and well-defined task. Although the theory behind agents has been around for some time, agents have become more prominent with the growth of the Internet. For example, various conventional software products are available that enable a user to configure an agent to search the Internet for certain types of information.

In practical terms, active data reporting agents include executable code that is configured to cause collection and transmission of data relating to an associated network resource to a data monitor. Such agents may be downloaded into one or more processors of the network resource, or in a network node with which the resource is associated.

The agent-based model for end-system assessment requires the installation of a software agent on the end system, e.g., at the network node, network element, or component which is desired to be monitored. The software agent provides a “presence point” on the end system to communicate with the monitoring server. The software agent may provide the ability to check the presence and the configuration of various software programs and network node and element configurations, and to perform other monitoring tasks, depending on the type of node or component in which the agent is associated with or is monitoring.

Such software agents are often called “active data reporting agents”, and may be assigned to a network resource or element that has been determined to have a data frequency change greater than a certain threshold value as appropriate to the network's requirements for data latency and monitoring.

There are generally two variations of the agent-based model. The first is a so-called “thick” agent-based model in which the “thick” agent provides a “built-in” solution that is typically operating system-centric and which also may require significant resources (memory, CPU, etc.) on the client side, i.e., at the network node or component level. The second is called a “thin” agent-based model: The “thin” agent requires minimal resources and no or little configuration on the client side (conventional thin agents are preconfigured, installed and updated by the assessment or monitoring server). The “thin” agent-based model is deployable in specific operating system or network environments based upon the monitoring system's support. Under the thin agent model in a client/server application, a client may be designed to be especially small so that the bulk of the data processing occurs on the server.

Multi-agent systems are computational systems in which several artificial agents, which are computer programs executed by one or more processors, interact or work together over a communications network to perform some set of task jointly, or to satisfy some set of goals. These systems may include homogenous or heterogeneous agents. Examples of such agents would be ones for detecting and diagnosing network problems occurring on a segment of a local area network; for scheduling the activities of a group of machines in a workcell on a factory floor; or for locating agents that locate a specific product for sale, and decide at what price to pay. Agents may further be characterized by whether they are benevolent (cooperative) or self-interested. Cooperative agents work toward achieving a set of shared goals, and self-interested agents have distinct goals, but may still interact to further their own goals. Agents often need to be semi-autonomous and highly adaptive due to their “open” operating environments, where the configuration capabilities of other agents and network resources change dynamically. Agent autonomy relates to an agent's ability to make its own decisions about what activities to do, when to do them, and to whom information should be communicated.

As illustrated in the depiction of background conventional network 100 in FIG. 1, conventional “thick” agents 110, 11, and 112 may reside in devices 120, 121, and 122, respectively, on network 100 and monitor activities on those devices. For example, an agent in router 121 can be assigned the role of monitoring packet transmissions, error conditions, and connections. The agents then make this information available to network management station 130. Network management station (NMS) 130 is the controlling device that gathers information from network agents, stores it in a management information base (MIB) 140 on disk or other media, and presents it to network administrators or clients for evaluation. Statistical information can show how network 100 is reacting to its current load and provide a way to detect potential problems.

Such conventional thick agents are installed in each of the various network nodes, and are each specifically assigned one or more roles and configured to monitor a specific type of network element or component. Network management station 130 must monitor each of the agents 110, 111, and 112, and must manage reassignment of roles when components or functionality on a network node changes or is deleted. Such reassignment of roles may involve significant monitoring activity by the network monitoring function, as well as significant data transmission when a new agent is required to be installed at one or more network nodes. The problem is exacerbated when the network is large and dynamically changing.

Application domains in which a multi-agent system technology may be appropriate typically have a naturally spatial, functional, or temporal decomposition of knowledge and expertise among agents. By structuring such applications as a multi-agent system rather than as a single agent, a system could achieve some or all of the following advantages: speed-up due to concurrent processing; less communication required because processing is located near the source of information; greater reliability because of the absence of a single point of failure; real-time responsiveness to processing, sensing, and effecting being co-located; and easier system development due to the modularity produced by dividing the program into agents.

Domains which have used a multi-agent approach include distributed situation assessment (e.g., network diagnosis, information gathering, and monitoring on the Internet); distributed resource scheduling and planning (e.g., factory scheduling, network management); distributed expert systems (e.g., concurrent engineering); telecommunications systems, both wired and wireless (e.g., mobile telephony); and financial management and transaction control systems (e.g., banking and/or stock transfer systems).

Other emerging uses of multi-agent systems are in layered systems architectures, in which agents at different layers need to coordinate their decisions for example, to achieve appropriate configurations of resources and computational processing, and in the design of resilient systems in which agents dynamically reorganized respond to changes in resource availability, software and hardware malfunction, and intrusions. In general, multi-agent systems provide a framework in which both the distribution of processing information and an application and the complexities that come from issues of scale can be handled in a natural way.

Preferably, agents are flexible, as they work with information of varying degrees of completeness and accuracy, and use resources of varying capabilities. This flexibility, however, requires agent autonomy, and is in direct contrast to the less autonomous characteristics of conventional agents utilized in current distributed processing applications.

One further disadvantage of agents is the deployment and management of the agents themselves, which can be a difficult task when the number of computers in the network rises to thousands. One way to help alleviate this difficulty is to assign “roles” to agents, which are then grouped logically. However, this is still a large task when you have a network with thousands of individual computers, network elements, and network nodes, particularly when the network is dynamically changing by the hour or even by the minute. Assignment of specific roles to each individual agent may impose an unacceptable burden on the system overall, particularly on the management or monitoring node or subsystem of the network.

### SUMMARY

Among other things, this disclosure provides embodiments of a system and method for network management in which various computer hardware, software running on the computer, and logical relationships between various computers and related peripherals may be discovered by one or more intelligent agents that may be configured based upon the discovered information. The configuration may include assignment of a role in the network in which the agent is installed. The assigned role may control the agent's behavior, and thereby optimize its data transmission and responses without external management being necessary.

Configuration of the agent may be further enhanced by the inference of more advanced logical information from factual information discovered by the agent, and such inference can be based upon logical rules for assignment of roles/configuration. The inference may take place locally in the agent, or the agent can make use of a centralized inference service. Aspects of this disclosure may allow presentation of the additional information gleaned from self-discovery of properties and roles by one or more agents to a user via a graphical user interface that is capable of revealing, for example, the logical organization of the network, instead of merely the physical organization of the network.

Various embodiments and implementations of such configurable agents are capable of easing the burden of managing hundreds or thousands of agents in a distributed network environment, and may also reduce network overhead traffic by minimizing the amount of data that is necessary to be sent to configure various agents in a different manner.

In one embodiment, a computer-implemented method of managing a computer network includes installing an agent, in each of a plurality of network nodes in the network, wherein the agent is configured to identify one or more types of network resources attached to a particular node with which said agent is associated; implement one or more roles for the agent based, at least in part, upon the one or more types of network resources identified by the agent; and monitoring a status of each agent. The agent may be an autonomous agent.

In another embodiment, a network management system includes an agent executing within an associated network node of the network, wherein the agent is configured to operate so as to identify one or more types of resources attached to the network node, and wherein the agent self-assigns one or more roles to itself based, at least in part, on an inference based upon the one or more types of resources identified by the agent.

In another embodiment, an article of manufacture includes a machine-readable medium containing computer-executable instructions therein. When the instructions are executed by a processor, an agent is installed in a network node associated with one or more network resources. The agent may be configured to carry out functions including identifying one or more types of network resources attached to the network node in which the agent is installed; implement one or more roles to itself based, at least in part, upon the one or more network resources identified by the agent; and configuring the agent in a desired manner based upon the one or more identified network resources.

### BRIEF DESCRIPTION OF THE DRAWINGS

FIG. 1 provides an illustration of a conventional network system in which conventional “thick” agents operate to monitor and report information obtained from various network nodes and elements;

FIG. 2 outlines a network configuration applicable to one or more embodiments of this disclosure in which plural servers are monitored by a management server over a network connection;

FIG. 3 outlines a different network configuration applicable to one or more embodiments of this disclosure in which plural database servers are arranged in a database cluster networked with another database server monitored by a management server over a network connection;

FIG. 4 provides a “self-discovery” process flowchart for an embodiment in which one or more of a number of pre-described properties are detected and roles are assigned based upon the detected properties;

FIG. 5 provides a “detect property” process flowchart related to an aspect of the embodiment of FIG. 4;

FIG. 6 provides a “detect role” process flowchart related to an aspect of the embodiment of FIG. 4; and

FIG. 7 provides an illustration of a network system using, self-discovering “thin” agents of this disclosure to monitor and report information obtained from various network nodes and elements, and in which the dashed lines represent reduced agent data transmission over the network in comparison to the conventional “thick” agent network system of FIG. 1.

### DETAILED DESCRIPTION

The articles “a” and “an” as used in this disclosure and appended claims are to be construed in their broadest sense, i.e., these words are not to be limited to mean the recitation of a single element unless specifically limited to only one, but rather may also be construed to mean “at least one” or “one or more.”

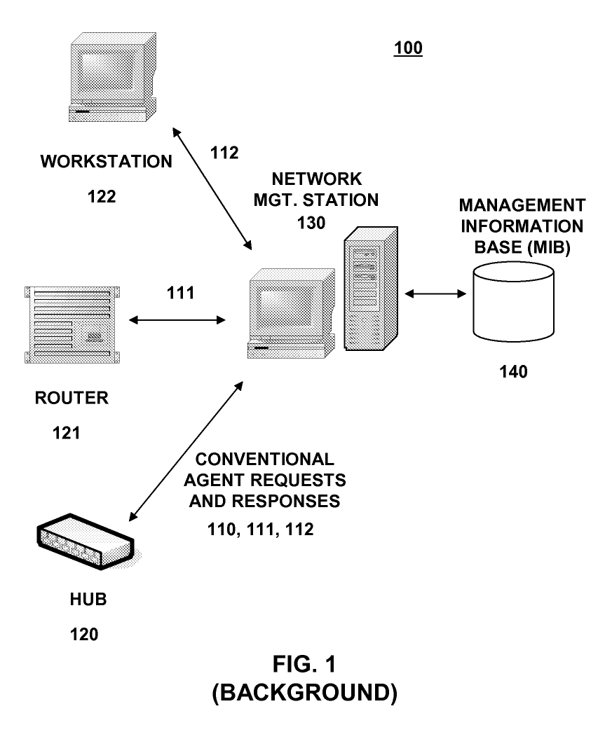

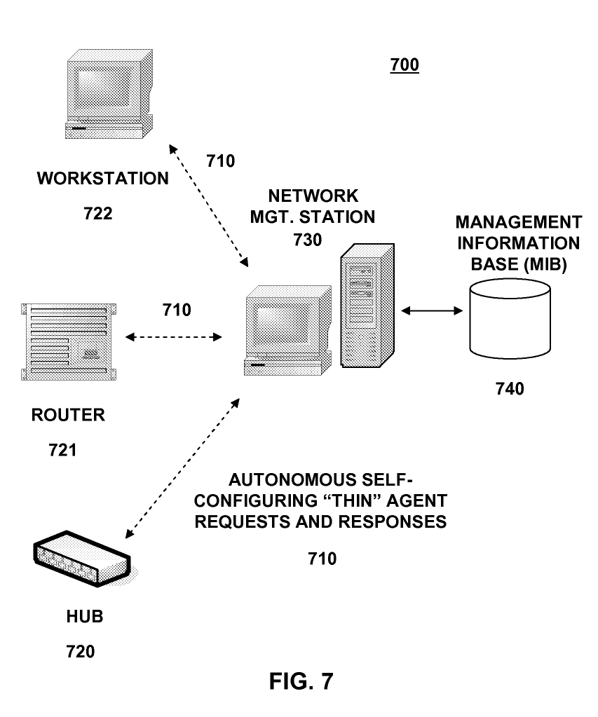

The embodiment of FIG. 7 is similar in some respects to the conventional network implementation of FIG. 1, with the notable exception of the difference in the types of agents installed on the various network nodes, e.g., hub 720, router 721, and workstation 722. In this embodiment, self-discovering “thin” agents 710 may be installed in each network node, and may be, at least initially, essentially identical in configuration and function. For example, agent 710 can be deployed to router 721 and, by a role-discovery/role-configuration process, can be assigned the role of monitoring packet transmissions, error conditions, and connections for router 721 either by self-assignment or by management system-assignment. Agent 710 then makes this information available to network management station 730. In contrast, conventional agents 110, 111, and 112 in FIG. 1 are specifically configured and deployed for each particular network node.

Network management station 730 may be configured as the controlling device that gathers information from network agents 710, and then stores it in MIB 740 on disk or other media, and presents it to network administrators or clients for evaluation by various conventional display and input/output components and techniques. Statistical information can show how network 700 is reacting to its current load and provide a way to detect potential problems, and can also monitor the activity of the various agents 710 in network 700.

Configurable thin agent 710 contains program code which, when installed and executed in an associated network node or element, acts to self-discover the type of network node or element that it is installed in. After such self-discovery, agent 710 may request that additional functionality be provided from a management node, e.g., network management system 730. Alternatively, agent 710 may merely report the type of node in which it is installed to management system 730, and management system 730 would then “push” the necessary tools and/or functionality to agent 710. Such additional functionality, appropriate for the particular network node in which agent 710 is installed, could alternatively be “pulled” by agent 710 and installed to supplement the self-discovery functionality of agent 710. If the network node changes configuration, either by hardware or software, or is completely eliminated, then the self-discovery functionality of agent 710 can be used again for further configuration by requesting the appropriate functionality from network management system 730, for example.

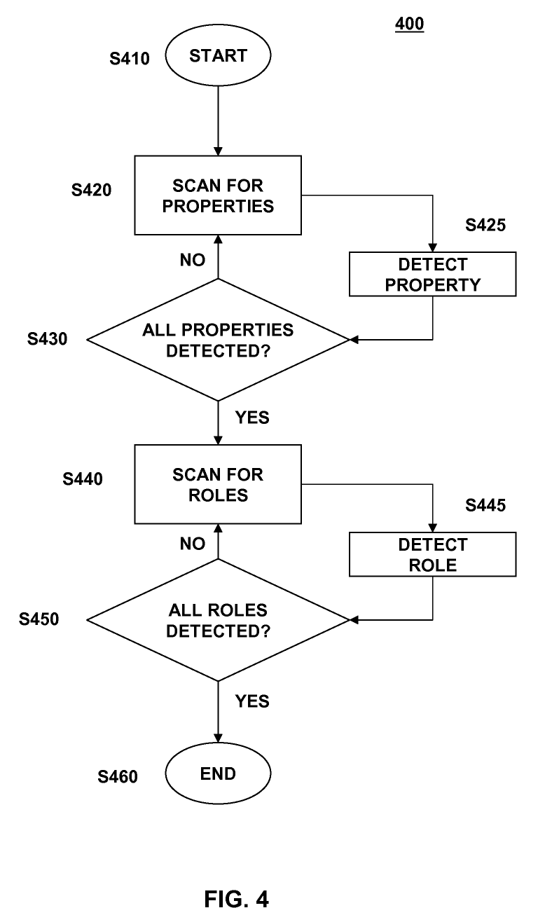

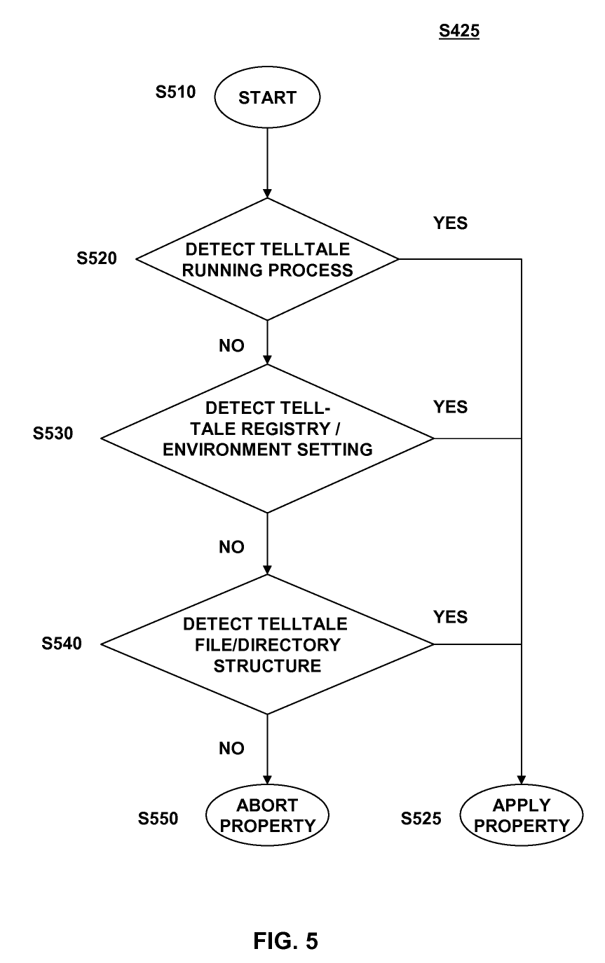

The flowchart of FIG. 4 illustrates one embodiment of a self-discovery process 400 that may be used by self-discovering thin agent 710. Process 400 is used by self-discovering thin agent 710 to detect one or more of a number of pre-described properties and to assign roles based upon the detected properties. Self-discovery process 400 starts at step S410, and proceeds to step S420 in which a predetermined list of properties applicable to various network management functions is used to evaluate the node where self-discovering thin agent 710 is installed. A property of the network node is detected at step S425, and a query is conducted at step S430 to determine whether all properties associated with the particular node have been detected. The “detect property” step S425 is illustrated in more detail in the flowchart of FIG. 5, discussed further below.

Examples of predetermined properties applicable to various network management functions may include, but are not limited to indications of “database installed,” “application server installed,” “database configured as cluster,” “multiple netcards in machine,” or “machine configured as bridge.”

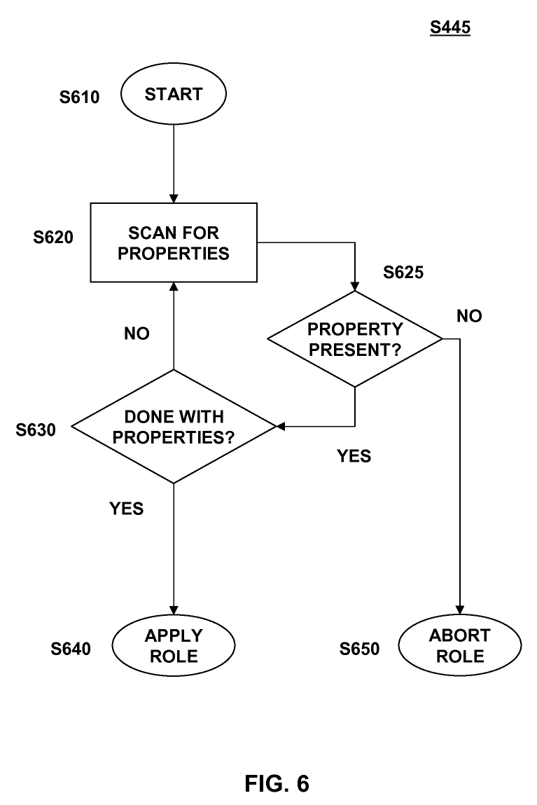

If all properties have been detected, then process 400 proceeds to step S440 where a predetermined list of roles applicable to various network management functions is used to further evaluate the node where self-discovering thin agent 710 is installed. A role of the network node is detected at step S445, and a query is conducted at step S450 to determine whether all properties associated with the particular node have been detected. The “detect role” step S445 is illustrated in more detail in the flowchart of FIG. 6, discussed further below. After all roles have been detected, process 400 concludes at step S460.

The difference between roles and properties may be characterized by the observation that roles are a more abstract concept than properties, and that properties or a single property can be mapped to a single role.

Examples of the predetermined classes of roles applicable to various network management functions and their mapping to various predetermined properties include three exemplary classes—PC, OS, and application. Although only three classes of roles are listed, this number can be adjusted according to system requirements and/or users' desires.

“PC” covers the roles of server-pc and workstation-pc. “OS” covers two roles, the family and specific operating system (OS) (the self-discovery process can assign these two roles—the family and the specific OS), including ms-windows-os (ms-windows-2000-os, ms-windows-2003-os, ms-windows-xp-os, ms-windows-vista-os); linux-os (ubuntu-linux-os, redhat-linux-os, debian-linus-os, suse-linux-os); bsd-os (apple-macosx-os, freebsd-os); systemv-os (sun-solaris-os, ibm-aix-os); and unix-os. “Application” covers the roles of appserver (bea-weblogic-appserver, ibm-websphere-appserver); db (oracle-database-db, ibm-db2-db); and agent (servicebus-agent, manager-agent, repository-agent). It should be noted that appserver, db, and agents can all be family roles on the same machine.

For example, the agent family roles are the ones pertaining to the network manager, and “service-bus” is the receiving agent for data discovery by the self-discovering agent. In one or more embodiments, the manager “pushes” data to the agents, and the repository is where data is pulled from.

The three roles discussed above—PC, OS, and application—may be assigned when the system is setup, and all three roles may readily be taken care of by a single agent. In a later stage, the roles may be discovered based on the installation. One note to the agents self discovery is that, when an agent network has been deployed for some time, and the administrators install a database on an existing machine, the agents will then discover that is has a DB role (self-discovery could be scheduled to run once a day, for example). Similarly, if the DB was uninstalled, the agent will no longer hold the DB roles and, as such, will not be part of the DB management group. Other roles could be based on third party software, for example.

The “detect property” step S425 is further illustrated in FIG. 5, which starts at step S510. At step S520, the presence of a “telltale” running process is evaluated. A running process in a computer/processor can provide an indication or “telltale” of the fact that a service/program/application is present on the node or system, i.e., it is indicative of that process. If a telltale running process is detected, then an appropriate property is applied at step S525. If not, the process of step S425 continues at step S530 where the presence of a “telltale” registry or environment setting is evaluated. If a telltale registry or environment setting is detected, then an appropriate property is applied at step S525. If not, the process of step S425 continues at step S540 where the presence of a “telltale” file or directory structure is evaluated. If a telltale file or directory structure is detected, then an appropriate property is applied at step S525. If not, the process of step S425 completes at step S550 which aborts the detect property process and returns processing to step S430 in FIG. 4.

As an example, a property “WINDOWS NT STYLE OPERATING SYSTEM” can be discovered by examining the operating system environment variable for the value “Windows_NT”. As another example, the property “FIREFOX BROWSER” can be discovered by detecting “firefox.exe” as a running process. By way of further example of a property, in many Windows® operating systems, a registry entry may contain a value for a database indicating that it is setup to work as a node in a cluster of databases. Additionally, specific user names, e.g., “USER_NAME” may be setup as a machine user. This USER_NAME property could then be used for grouping multiple machines in which “USER_NAME” is an authorized user.

There can be different ways of discovering properties other than the exemplary “telltales” discussed above. For example, properties may be discovered by lookup of a value from a database table, from a computer registry (e.g., in various Windows® OS), of a file system structure, application-specific data files, or values from application-specific application program interfaces (API) (e.g., MySQL API).

The “detect role” step S445 is further illustrated in FIG. 6, which starts at step S610. At step S620, properties relating to a specific role are scanned for the network node. An evaluation is made at step S625 whether a property relating to the role is present. If not, then the role is aborted at step S650. If a property relating to the role is detected, an evaluation is made at step S630 as to whether more properties relating to the role are present, and if so, then the scanning of step S620 and evaluation of step S625 are repeated. If no further properties relating to the role are discovered, then the specific role is applied at step S640. Processing returns to step S450 in FIG. 4, where additional roles can be scanned based on the presence of one or more related properties.

A certain number of properties needs to be present for the role to be detected and applied. As an example, “WINDOWS FIREFOX BROWSER” can be applied if properties “WINDOWS NT STYLE OPERATING SYSTEM” and “FIREFOX BROWSER” are present. As mentioned above, multiple properties may map to a single role, or a single property may map to a single role.

Further examples of roles may include, but are not limited to “USER_NAME'S WINDOWS MACHINE” if properties “WINDOWS NT STYLE OPERATING SYSTEM” and “USER IS ‘USER_NAME’” are present; the role of “ORACLE CLUSTER 1” if properties “ORACLE DATABASE” and “DATABASE CONFIGURED AS CLUSTER” are present; and the role of “NETWORK BRIDGE” if the properties “MULTIPLE NETCARDS INSTALLED” and “MACHINE CONFIGURED AS BRIDGE” are present.

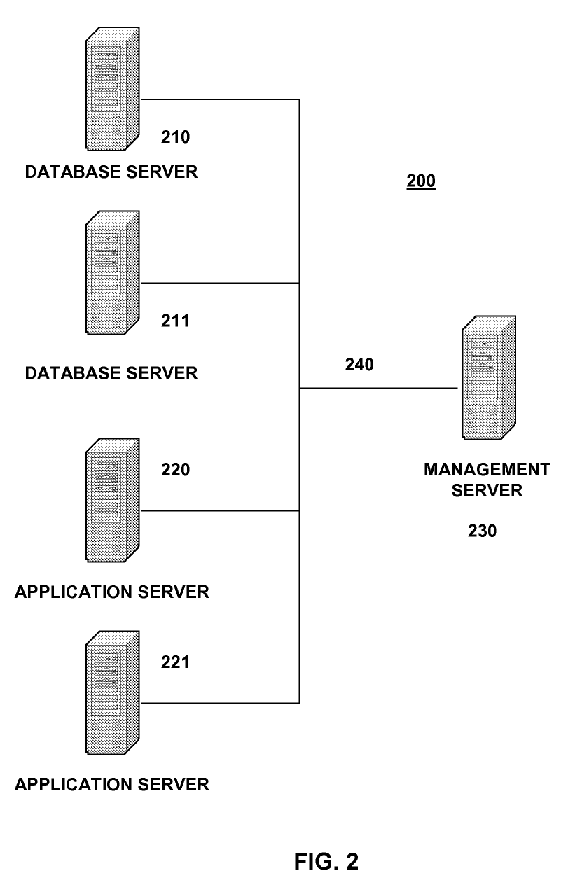

In the exemplary embodiment of FIG. 2, network configuration 200 is illustrated in which multiple database servers 210, 211 and application servers 220, 221 are monitored by management server 230 over network connection 240. In this and all embodiments, network connection 240 may be a conventional wired local area network (LAN) or wide area networks (WAN), the internet, or conventional wireless networks, including wireless networks implemented for mobile telephony. Thin agents 710 are not illustrated in FIG. 2 for simplicity.

In such a configuration with five physical machines, i.e., two database servers, two application servers, and a management server, the self-discovering thin agents deployed on each machine can discover database software on the two database servers, and assign the role of “database server” to itself. On the two machines with application server software, the thin agent will discover the application software and assign the role of “application server” to itself Similarly, the management software could be discovered on the management server, and the installed agent could then assign the role of “management server” to itself As the predefined roles also define behavior, the application servers and database servers start to send relevant information to the management server. The dynamic behavior of thin agent 710 will ensure that if a piece of software is installed or uninstalled, the roles will automatically be updated and thus, with less management, always give an accurate status of the network, and reduce irrelevant data being sent over the network. User management is thereby capable of being implemented using the general relationships of the roles instead of managing specific machines.

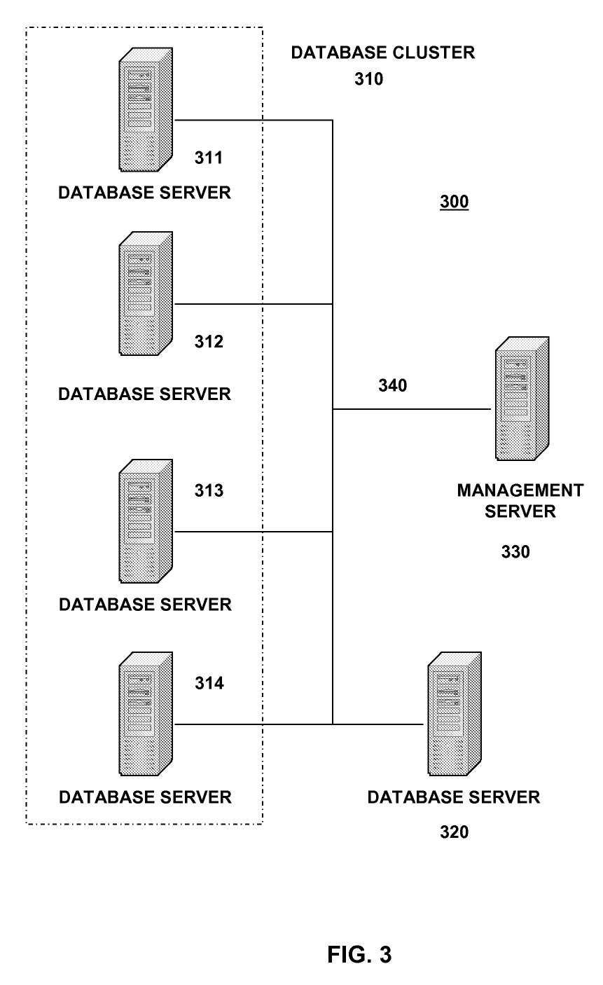

In the exemplary embodiment of FIG. 3, network configuration 300 is illustrated in which database cluster 310 includes multiple database servers 311, 312, 313, and 314, and stand-alone database server 320 are monitored by management server 330 over network connection 340.

In such a configuration with six physical machines including a management server, and where five of the machines have database software installed and four are arranged in a database cluster, the various agents will assign the role of “database server” to all five database servers. The agents' self-discovery process also relays information about the relationship between the four database cluster machines, which can utilize inference to determine that it is a cluster, and assign the extra “database cluster” role to the four database servers in the cluster. If several clusters are found in a more complicated scenario, they can be enumerated in another role in order to manage them separately, while the “database cluster” role would be used to address all the cluster machines.

In a further exemplary embodiment, a computer-implemented method of managing a computer network includes installing an agent in each of a plurality of network nodes in the network. The agent may be configured to identify one or more types of network resources attached to a particular node with which the agent is associated. The agent may then self-assign one or more roles to itself based, at least in part, upon one or more types of network resources identified by the agent. Further, a monitoring function may be used to monitor a status of each installed agent.

In a further aspect of this embodiment, the agent may be configured to perform functions associated with the one or more types of network resources identified by the agent. Such configuring may include pushing functionality from a management node to the agent or pulling functionality from a management node to the agent.

In another aspect, the agent self-discovering by extracting executable code contained in the agent to a memory in the network node. Upon execution, the executable code would be suitable to perform functions associated with the type of network source identified by the agent.

Based upon information detected regarding a configuration of the particular network node, an assigned role of the agent may be inferred. Such an inference may be carried out by the agent in a “self-configuring” mode, or the inference may be made by a management node in the network. There are technical tradeoffs with either choice, but it may be beneficial in some applications to offload the inference processing to an inference engine in a management node to support use of simpler self-discovering agents.

In a further aspect of this embodiment, the status of multiple agents deployed throughout the network may be monitored at the management node of the network.

In another aspect, and in response to detecting a change in the network node hardware and/or software functionality, the agent may be used to dynamically update one or more role assignments made to itself. Such dynamic updating may further include deleting a role of the agent in response to removing either a hardware component or a software function at the particular network node, or it may include the assignment of an additional role to the agent in response to adding either a hardware component or a software function at the particular network node. The agent may be further configured to transmit information regarding a hardware and/or software configuration at the particular node to the management node.

The self-assignment of one or more roles by the agent may include detecting, through a self-discovery process, at least one property of a number of predetermined properties relating to a network resource attached to the particular node, and one or more roles may be assigned to the agent based upon one or more detected properties. Such predetermined properties may include one or more of the exemplary properties discussed above.

In another aspect of this embodiment, and as previously discussed with respect to FIG. 5, one or more properties may be detected by detecting one or more of a telltale running process, a registry entry, an environment setting, a file structure, and a directory structure. Further, the assignment of one or more roles by the agent may be carried out by correlating one or more detected properties with a single role, or a single property may be mapped to the single role.

In another embodiment, a network management system includes an agent executing within an associated network node of the network. The agent may be configured to operate so as to identify one or more types of resources attached to the network node. Further, the agent may be configured to self-assign one or more roles to itself based, at least in part, on an inference based upon the one or more types of resources identified by the agent.

In another aspect of this embodiment, the system may further include a monitoring node configured to monitor the status of the system, including multiple agents. Further, the agent may be configured to perform functions associated with the types of network resources based upon the inference.

In another aspect of this embodiment, the agent is configured to receive functionality pushed from a management node to the agent based upon the inference. Alternatively, the agent may be configured to receive functionality pulled from a management node based upon the inference.

In another aspect of this embodiment, the agent may be programmed to self-configure by extracting executable code contained in the agent to a memory. Upon execution, suitable executable code can be made to perform functions associated with the identified type of resource at the network node. This aspect may or may not be desirable depending on the particular network configuration and constraints, as this would involve the use of “thicker” agents, but could reduce network traffic normally associated with configuring a thin agent to perform one or more roles at a network node based upon detected properties at the node.

In another aspect, the agent may be assigned a role based, at least in part, from an inference made from detected information regarding a configuration of the network node. Although, as mentioned above, it would rely upon a more capable agent and possibly “thicker” agent, the agent may be configured to infer, by itself, the assigned role from the detected information.

In another aspect of this system, a central or management node may be used to infer the assigned role of the agent using the information detected by the agent. This would allow reduction of the processing required by the agent and its associated node by offloading such processing to the management node.

In another aspect of this embodiment, the management node may be configured to monitor a status and manage agents installed throughout the system.

In another aspect, the agent may be configured to perform a dynamic update to self-assignments of roles to itself in response to a change in either hardware attached to the particular network node, or to a software function performed at the particular network node. Such dynamic update may include deleting a role of the agent in response to removing either a hardware component or a software function at the particular network node, or the dynamic update may include assigning an additional role to the agent in response to adding either a hardware component or a software function at the particular network node.

In a further aspect of this embodiment, the agent may be configured to relay information regarding a hardware and/or software configuration at the particular node to the management node.

In another aspect of this embodiment, the agent may be configured to carry out a self-discovery process in which at least one property of a number of predetermined properties is detected, and wherein said one or more roles are assigned based upon the detected properties. Such predetermined properties may include exemplary properties discussed above.

In a related aspect of this embodiment, a property may be discovered by the agent detecting one or more of a telltale running process, a registry entry, an environment setting, a file structure, and a directory structure. The assignment of one or more roles by the agent may be done by correlating one or more detected properties with a single role, or a single property may be mapped to the single role.

Another embodiment is directed to computer software embodied in an article of manufacture having a machine-readable medium thereon. The computer software may be implemented by computer-executable instructions which, when executed by a processor, cause an agent to be installed in a network node associated with one or more network resources. The self-discovering agent may be configured to carry out functions including identifying one or more types of network resources attached to the network node in which the agent is installed. The agent may self-assign one or more roles to itself based, at least in part, upon the one or more network resources identified by the agent. The agent may then be configured in a desired manner based upon the network resources associated with the agent.

In another aspect of this embodiment, the agent is configured to request that additional computer-executable instructions be transmitted from a source external to the network node so as to enable the agent to provide the desired functionality based upon the one or more identified network resources. Such an external source may include, for example, a management node of the network. This aspect relies upon a “thin” agent, but uses network bandwidth to provide the desired functionality to the agent as it is configured.

The above description is intended to describe various exemplary embodiments and aspects of this disclosure, and is not intended to limit the spirit and scope of the following claims.

What is claimed is:

1. A computer-implemented method of managing a computer network, the method comprising:
installing an agent in each of a plurality of network nodes in the network, wherein the agent is configured to identify a type of network resource attached to a particular node with which said agent is associated;
assigning a role to the agent based, at least in part, upon the type of network resource identified by the agent; and
executing a function associated with the assigned role in the particular node.

2. The method of claim 1, further comprising monitoring a status of each agent.

3. The method of claim 1, further comprising configuring the agent to perform the function associated with the type of network resource identified by the agent.

4. The method of claim 3, wherein said configuring comprises pushing functionality from a management node to the agent.

5. The method of claim 3, wherein said configuring comprises pulling functionality from a management node to the agent.

6. The method of claim 3, wherein said configuring comprises the agent self-configuring by extracting executable code contained in the agent to a memory, said executable code being suitable, upon execution, to perform functions associated with the identified type of network resource.

7. The method of claim 1, further comprising inferring an assigned role of the agent from detected information regarding a configuration of the particular network node.

8. The method of claim 7, wherein said inferring is carried out by the agent.

9. The method of claim 7, wherein said inferring is carried out by a management node.

10. The method of claim 1, wherein a status of plural agents deployed throughout the network is monitored at a management node of the network.

11. The method of claim 1, further comprising the agent dynamically updating a role assignment to itself in response to a change in either hardware or software functionality at the particular network node.

12. The method of claim 11, wherein said dynamically updating comprises deleting a role of the agent in response to removing either a hardware component or a software function at the particular network node.

13. The method of claim 11, wherein said dynamically updating comprises assigning an additional role to the agent in response to adding either a hardware component or a software function at the particular network node.

14. The method of claim 1, further comprising transmitting information regarding a hardware and/or software configuration at the particular node to a management node.

15. The method of claim 14, wherein the information is relayed to the management node by the agent.

16. The method of claim 1, wherein said assigning a role by the agent comprises detecting, through a self-discovery process, a property of a plurality of predetermined properties relating to a network resource attached to the particular node with which said agent is associated, and wherein said role is assigned based upon said detected property.

17. The method of claim 16, wherein said property is detected by detecting one or more of a telltale running process, a registry entry, an environment setting, a file structure, and a directory structure.

18. The method of claim 1, wherein said assigning a role by the agent comprises correlating one or more detected properties with a single role.

19. The method of claim 18, wherein a single property is mapped to the single role.

20. A network management system, the system comprising:
an agent executing within an associated network node of the network, said agent being configured to operate so as to identify a type of resource attached to the network node,
wherein the agent self-assigns a role to itself based, at least in part, on an inference based upon the type of resource identified by the agent.

21. The system of claim 20, further comprising a monitoring node configured to monitor a status of the agent.

22. The system of claim 20, wherein the agent is configured to perform functions associated with the type of network resource based upon the inference.

23. The system of claim 20, wherein said agent is configured to receive functionality pushed from a management node to the agent based upon the inference.

24. The system of claim 20, wherein said agent is configured to receive functionality pulled from a management node based upon the inference.

25. The system of claim 20, wherein said agent is configured to self-configure by extracting executable code contained in the agent to a memory, said executable code being suitable, upon execution, to perform functions associated with the identified type of resource at the network node.

26. The system of claim 20, wherein said agent is assigned a role based, at least in part, from an inference made from detected information regarding a configuration of the network node.

27. The system of claim 26, wherein said agent is configured to infer the assigned role from the detected information.

28. The system of claim 20, further comprising a central node that infers the assigned role of the agent using the detected information.

29. The system of claim 20, further comprising a management node that is configured to monitor a status of the agent.

30. The system of claim 20, wherein the agent is configured to perform a dynamic update to a role assignment to itself in response to a change in either hardware attached to the particular network node, or to a software function performed at the particular network node.

31. The system of claim 20, wherein said dynamic update comprises deleting a role of the agent in response to removing either a hardware component or a software function at the particular network node.

32. The system of claim 20, wherein said dynamic update comprises assigning an additional role to the agent in response to adding either a hardware component or a software function at the particular network node.

33. The system of claim 20, wherein said agent is configured to relay information regarding a hardware and/or software configuration at the particular node to a management node.

34. The system of claim 20, wherein said agent is configured to carry out a self-discovery process in which a property of a plurality of predetermined properties is detected, and wherein said role is assigned based upon said detected property.

35. The system of claim 34, wherein said property is discovered by detecting one or more of a telltale running process, a registry entry, an environment setting, a file structure, and a directory structure.

36. The system of claim 20, wherein said assigning the role by the agent comprises correlating multiple detected properties with a single role.

37. The system of claim 36, wherein a single property is mapped to the single role.

38. An article of manufacture comprising a machine-readable medium containing computer-executable instructions therein which, when executed by a processor, cause an agent to be installed in a network node associated with one or more network resources, said agent being configured to carry out the functions of:
identifying one or more types of network resources attached to the network node in which said agent is installed;
assigning one or more roles to itself based, at least in part, upon the one or more network resources identified by the agent; and
configuring the agent in a desired manner based upon the one or more identified network resources.

39. The article of manufacture of claim 38, wherein said configuring comprises the agent self-extracting and executing only desired functionality from the computer-executable instructions based upon the one or more identified network resources.

40. The article of manufacture of claim 38, wherein said configuring comprises the agent receiving computer-executable instructions transmitted from a source external to the network node so as to enable the agent to provide the desired functionality based upon the one or more identified network resources.

41. The article of manufacture of claim 40, wherein said computer-executable instructions are received after said agent requests that the desired functionality be provided.
